(19) United States
(12) Patent Application Publication
(10) Pub. No.: US 2025/0167211 A1
(43) Pub. Date: May 22, 2025

(54) METHODS OF MANUFACTURING LITHIATED SILICON OXIDE-CONTAINING NEGATIVE ELECTRODES INCLUDING NITRATE ADDITIVES AND BATTERIES INCLUDING THE SAME

(71) Applicant: GM GLOBAL TECHNOLOGY OPERATIONS LLC, Detroit, MI (US)

(72) Inventors: Bradley R. FRIEBERG, Farmington Hills, MI (US); Chuanlong Wang, Troy, MI (US); Xiaosong Huang, Novi, MI (US)

(21) Appl. No.: 18/514,142

(22) Filed: Nov. 20, 2023

(51) Int. Cl. H01M 4/1391; H01M 4/02; H01M 4/04; H01M 4/1393; H01M 4/485; H01M 4/587; H01M 4/62; H01M 4/66; H01M 10/0525; H01M 10/0567; H01M 10/0569; H01M 10/058

(52) U.S. Cl. CPC H01M 4/1391; H01M 4/0404; H01M 4/0445; H01M 4/1393; H01M 4/485; H01M 4/587; H01M 4/622; H01M 4/661; H01M 10/0525; H01M 10/0567; H01M 10/0569; H01M 10/058; H01M 2004/027; H01M 2300/0037

(57) ABSTRACT

A battery that cycles lithium ions includes a negative electrode including an electroactive negative electrode material, a polymer binder, and a nitrate additive. The negative electrode is manufactured by depositing a precursor mixture on a substrate to form a precursor layer. The precursor mixture includes an electroactive negative electrode material, a polymer binder, a nitrate additive, and an aqueous solvent. The electroactive negative electrode material includes silicon, silicon oxide, lithiated silicon suboxide, graphite, or a combination thereof. The aqueous solvent is removed from the precursor layer to form the negative electrode on the substrate.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to methods of manufacturing electrodes of batteries that cycle lithium ions, and more particularly to methods of manufacturing negatives electrodes including silicon oxide-based electroactive materials.

Batteries that cycle lithium ions generally include a positive electrode, a negative electrode spaced apart from the positive electrode, and an ionically conductive electrolyte that provides a medium for the conduction of lithium ions between the positive and negative electrodes during discharge and charge of the batteries. The electrolyte may be formulated to exhibit high ionic conductivity, good thermal stability, a wide electrochemical stability window, and the ability to form an ionically conductive solid electrolyte interphase (SEI) on surfaces of the negative and/or positive electrodes. The electrodes oftentimes have a composite structure comprising an electrochemically active (electroactive) material, an electrically conductive material, and a polymer binder. Silicon is a desirable electroactive material for the negative electrode due to its high theoretical specific capacity.

The composite electrodes may be manufactured by depositing a slurry comprising the electroactive material, the electrically conductive material, and the polymer binder in a solvent on substrate in the form of a continuous layer, followed by removal of the solvent. The polymer binder and the solvent are generally selected to avoid undesirable chemical reactions with the electroactive material and to ensure good solubility of the polymer binder in the solvent.

### SUMMARY

In a method of manufacturing a negative electrode for a battery that cycles lithium ions, in accordance with one or more embodiments of the present disclosure, a precursor mixture is deposited on a substrate to form a precursor layer. The precursor mixture comprises an electroactive negative electrode material, a polymer binder, a nitrate additive, and an aqueous solvent. The electroactive negative electrode material comprises silicon, silicon oxide, lithiated silicon suboxide, graphite, or a combination thereof. The aqueous solvent is removed from the precursor layer to form the negative electrode on the substrate.

The nitrate additive may comprise lithium nitrate (LiNO₃), sodium nitrate (NaNO₃), potassium nitrate (KNO₃), copper nitrate (Cu(NO₃)₂), or a combination thereof.

The nitrate additive may constitute, by weight, greater than or equal to about 0.01% and less than or equal to about 2% of the negative electrode.

In embodiments, the precursor mixture may be prepared by preparing a binder solution comprising the polymer binder and at least a portion of the aqueous solvent, and then introducing the electroactive negative electrode material and the nitrate additive into the binder solution to form the precursor mixture. The method may further comprise introducing an electrically conductive material into the binder solution prior to introducing the electroactive negative electrode material and the nitrate additive into the binder solution.

In embodiments, the precursor mixture may be prepared by preparing a first solution comprising the polymer binder, the nitrate additive, and at least a portion of the aqueous solvent, and then introducing the electroactive negative electrode material into the first solution to form the precursor mixture. The method may further comprise introducing an electrically conductive material into the first solution prior to introducing the electroactive negative electrode material into the first solution.

In embodiments, the precursor mixture may be prepared by preparing a binder solution comprising the polymer binder and the aqueous solvent, preparing a nitrate solution comprising the nitrate additive and the aqueous solvent, and mixing the binder solution, the nitrate solution, and the electroactive negative electrode material together to form the precursor mixture. The method may further comprise introducing an electrically conductive material into the binder solution prior to mixing the binder solution with the nitrate solution and the electroactive negative electrode material.

The polymer binder may comprise styrene butadiene rubber (SBR), carboxymethyl cellulose (CMC), polyacrylic acid (PAA), sodium alginate, or a combination thereof.

The polymer binder may constitute, by weight, greater than or equal to about 2% and less than or equal to about 10% of the negative electrode.

The precursor mixture may further comprise an electrically conductive material/The electrically conductive material may constitute, by weight, greater than or equal to about 2% and less than or equal to about 10% of the negative electrode.

The electroactive negative electrode material may constitute, by weight, greater than or equal to about 80% and less than or equal to about 97% of the negative electrode.

The electroactive negative electrode material may further comprise graphite.

In a method of manufacturing a battery that cycles lithium ions, in accordance with one or more embodiments of the present disclosure, a precursor mixture is deposited on a copper current collector to form a precursor layer. The precursor mixture comprises an electroactive negative electrode material, a polymer binder, a nitrate additive, and an aqueous solvent. The electroactive negative electrode material comprises silicon, silicon oxide, lithiated silicon suboxide, graphite, or a combination thereof. The nitrate additive comprises lithium nitrate (LiNO₃), sodium nitrate (NaNO₃), potassium nitrate (KNO₃), copper nitrate (Cu(NO₃)₂), or a combination thereof. The aqueous solvent is removed from the precursor layer to form a negative electrode on the copper current collector. The negative electrode and the copper current collector are assembled into a stack comprising a positive electrode disposed on a positive electrode current collector and a separator sandwiched between opposed facing surfaces of the negative electrode and the positive electrode. The positive electrode comprises lithium ions.

The nitrate additive may comprise LiNO₃. In such case, the LiNO₃ may constitute, by weight, greater than or equal to about 0.05% and less than or equal to about 0.4% of the negative electrode.

The polymer binder may comprise styrene butadiene rubber (SBR), carboxymethyl cellulose (CMC), polyacrylic acid (PAA), sodium alginate, or a combination thereof.

The method may further comprise infiltrating the negative electrode, the positive electrode, and the separator with an electrolyte comprising a lithium salt in a polar aprotic organic solvent. The electrolyte may be substantially free of nitrate compounds.

The method may further comprise charging the battery by electrically coupling the negative electrode current collector and the positive electrode current collector to a power source such that lithium ions are released from the positive electrode and incorporated into the negative electrode. During charge of the battery, the nitrate additive may react with the electroactive negative electrode material to form an electrically insulating and ionically conductive solid interphase layer on surfaces of the electroactive negative electrode material.

The polar aprotic organic solvent may comprise a mixture of a cyclic carbonate and a linear carbonate.

A battery that cycles lithium ions, in accordance with one or more embodiments of the present disclosure, comprises a negative electrode, a positive electrode spaced apart from the negative electrode, a separator sandwiched between the negative electrode and the positive electrode, and an electrolyte infiltrating the negative electrode, the positive electrode, and the separator. The negative electrode comprises electroactive negative electrode material particles, nitrate additive particles, and an electrically conductive carbon-based material intermingled with a polymer binder. The electroactive negative electrode material particles comprise silicon, silicon oxide, lithiated silicon suboxide, graphite, or a combination thereof. The nitrate additive particles comprise lithium nitrate (LiNO₃), sodium nitrate (NaNO₃), potassium nitrate (KNO₃), copper nitrate (Cu(NO₃)₂), or a combination thereof. The nitrate additive particles constitute, by weight, greater than or equal to about 0.05% and less than or equal to about 0.4% of the negative electrode. The polymer binder comprises styrene butadiene rubber (SBR), carboxymethyl cellulose (CMC), polyacrylic acid (PAA), sodium alginate, or a combination thereof. The positive electrode comprises an electroactive positive electrode material. The electrolyte comprises a lithium salt in a polar aprotic organic solvent. The electrolyte and the separator are substantially free of nitrate compounds.

The electrolyte may further comprise an electrolyte additive selected from the group consisting of lithium bis(oxalato)borate (LiBOB), lithium difluoro(oxalate)borate (LiDFOB), and lithium fluoromalonato(difluoro)borate (LIFMDFB). The electrolyte additive may constitute, by weight, greater than or equal to about 0.5% and less than or equal to about 2% of the electrolyte.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a schematic perspective view of an automotive vehicle powered by a battery pack that includes multiple battery modules.

FIG. 2 is a schematic cross-sectional view of a portion of one of the battery modules of FIG. 1, the battery module including multiple electrochemical cells or batteries that cycle lithium ions.

FIG. 3 is a schematic cross-sectional view of a battery that cycles lithium ions, the battery comprising a positive electrode, a negative electrode, a porous separator, and an electrolyte infiltrating the positive and negative electrodes and the porous separator.

FIGS. 4, 5, and 6 are flow diagrams respectively depicting steps in first, second, and third methods of manufacturing the negative electrode of FIG. 3.

In the drawings, reference numbers may be reused to identify similar and/or identical elements.

### DETAILED DESCRIPTION

The presently disclosed methods can be used to manufacture negative electrodes for batteries that cycle lithium ions. The negative electrodes comprise an electroactive material comprising lithiated silicon suboxide (LSO), a polymer binder, and a nitrate additive. During manufacture of the negative electrodes, a precursor mixture comprising the electroactive material, the polymer binder, and the nitrate additive in an aqueous solvent is deposited on a substrate to form a precursor layer, and then the aqueous solvent is removed from the precursor layer to form the negative electrode. The nitrate additive has high solubility in the aqueous solvent, which allows the nitrate additive to be uniformly and intimately mixed with the electroactive material in the precursor mixture and in the resulting negative electrode. During initial charge and cycling of the battery, the nitrate additive is formulated to react with the electroactive material in the negative electrode to form a solid interphase layer on the electroactive material that prevents or inhibits undesirable side reactions from occurring between the electroactive material and the electrolyte.

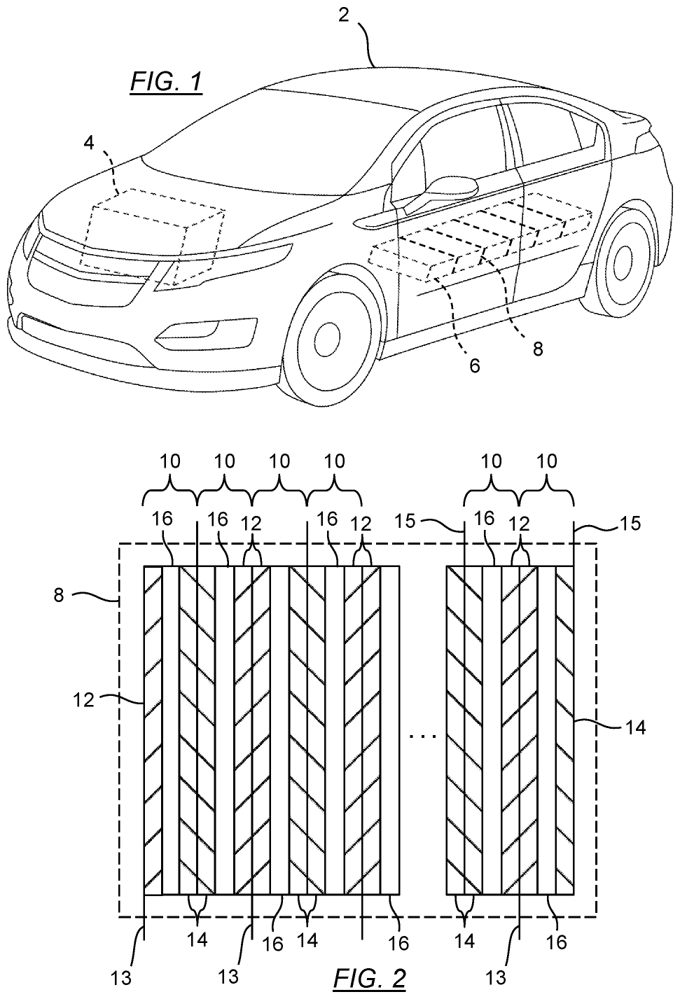

FIG. 1 depicts an automotive vehicle 2 powered by an electric motor 4 that draws electricity from a battery pack 6 including one or more battery modules 8. The battery modules 8 may be electrically coupled together in a series and/or parallel arrangement to meet desired capacity and power requirements of the electric motor 4. The vehicle 2 may be an all-electric vehicle and may be powered exclusively by the electric motor 4, or the vehicle 2 may be a hybrid electric vehicle and may be powered by the electric motor 4 and by an internal combustion engine (not shown).

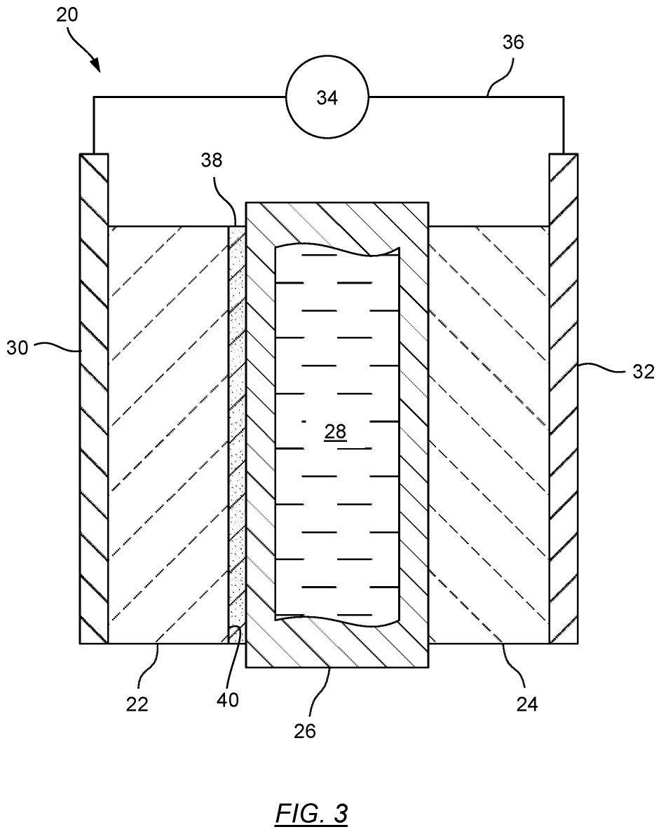

As shown in FIG. 2, each battery module 8 includes one or more electrochemical cells or batteries 10 that cycle lithium ions. In practice, the batteries 10 in the battery module 8 are oftentimes assembled as a stack of layers, including negative electrode layers 12, negative electrode current collectors 13, positive electrode layers 14, positive electrode current collectors 15, and separator layers 16. Each battery 10 is defined by a negative electrode layer 12 and a positive electrode layer 14, which are spaced apart from each other by a separator layer 16. In practice, the separator layer 16 may be infiltrated with an electrolyte that provides a medium for the conduction of lithium ions between the negative electrode layer 12 and the positive electrode layer 14, or the separator layer 16 itself may function as an electrolyte. The negative electrode layers 12 are disposed on and in electrical communication with the negative electrode current collectors 13 and the positive electrode layers 14 are disposed on an in electrical communication with the positive electrode current collectors 15. As shown in FIG. 2, for efficiency, the layers may be stacked such that some of the negative electrode current collectors 13 and some of the positive electrode current collectors 15 are double sided and respectively include negative electrode layers 12 or positive electrode layers 14 on both sides thereof. In this arrangement, adjacent negative electrode layers 12 and positive electrode layers 14 respectively share a single negative electrode current collector 13 or a positive electrode current collector 15.

FIG. 3 depicts an electrochemical cell or battery 20 that cycles lithium ions. The battery 20 can generate an electric current during discharge, which may be used to supply power to a load device (e.g., an electric motor 4), and can be charged by being connected to a power source. Like the batteries 10 depicted in FIGS. 1 and 2, in aspects, the battery 20 may be used to supply power to an electric motor 4 of an automotive vehicle 2. Additionally or alternatively, the battery 20 may be used in other transportation applications (e.g., motorcycles, boats, tractors, buses, motorcycles, mobile homes, campers, tanks, and aircraft), and may be used to provide electricity to stationary and/or portable electronic equipment, components, and devices used in a wide variety of other industries and applications, including industrial, residential, and commercial buildings, consumer products, industrial equipment and machinery, agricultural or farm equipment, and heavy machinery, by way of nonlimiting example.

The battery 20 comprises a negative electrode 22, a positive electrode 24, a separator 26, and an electrolyte 28 that provides a medium for conduction of lithium ions between the negative electrode 22 and the positive electrode 24. The negative electrode 22 is disposed on a major surface of a negative electrode current collector 30 and the positive electrode 24 is disposed on a major surface of a positive electrode current collector 32. The negative electrode 22 includes a solid interphase layer 38 disposed on surfaces 40 thereof. In practice, the negative electrode current collector 30 and the positive electrode current collector 32 are electrically coupled to a power source or load 34 (e.g., the electric motor 4) via an external circuit 36. The negative electrode 22 and the positive electrode 24 are formulated such that, when the battery 20 is at least partially charged, an electrochemical potential difference is established between the negative electrode 22 and the positive electrode 24. During discharge of the battery 20, the electrochemical potential established between the negative electrode 22 and the positive electrode 24 drives spontaneous reduction and oxidation (redox) reactions within the battery 20 and the release of lithium ions and electrons at the negative electrode 22. The released lithium ions travel from the negative electrode 22 to the positive electrode 24 through the separator 26 and the electrolyte 28, while the electrons travel from the negative electrode 22 to the positive electrode 24 via the external circuit 36, which generates an electric current. After the negative electrode 22 has been partially or fully depleted of lithium, the battery 20 may be charged by connecting the negative electrode 22 and the positive electrode 24 to the power source 34, which drives nonspontaneous redox reactions within the battery 20 and the release of the lithium ions and the electrons from the positive electrode 24. The repeated discharge and charge of the battery 20 may be referred to herein as “cycling,” with a full charge event followed by a full discharge event being considered a full cycle.

The negative electrode 22 is formulated to store and release lithium ions to facilitate charge and discharge, respectively, of the battery 20. The negative electrode 22 may be in the form of a continuous porous layer of material disposed on a major surface of the negative electrode current collector 30. The negative electrode 22 comprises an electrochemically active (electroactive) material, a polymer binder, a nitrate additive, and optionally an electrically conductive material. The electroactive material of the negative electrode 22 may be referred to herein as an “electroactive negative electrode material.” In embodiments, the electroactive material of the negative electrode 22 may be a particulate material and particles of the electroactive material may be intermingled with the polymer binder, the nitrate additive, and the optional electrically conductive material in the negative electrode 22. The negative electrode 22 may have a thickness of greater than or equal to about 30 micrometers (μm), optionally greater than or equal to about 50 μm, optionally greater than or equal to about 70 μm, or optionally greater than or equal to about 100 μm and less than or equal to about 500 μm.

The electroactive material of the negative electrode 22 is formulated to store and release lithium ions by undergoing a reversible redox reaction with lithium during charge and discharge of the battery 20. The electroactive material may constitute, by weight, greater than or equal to about 80%, or optionally greater than or equal to about 90%, and less than or equal to about 97%, or optionally less than or equal to about 95% of the negative electrode 22.

The electroactive material of the negative electrode 22 comprises a lithiated silicon suboxide (LSO) material. Prior to initial charge of the battery 20, the LSO material may have the following formula (1):

LiₓSiO_{y}, (1)

where 0<x≤2 and 0<y≤2.

In practice, the LSO material may comprise multiple different Si-, Li-, and/or O-containing chemical compounds, with the overall composition of the LSO material being represented by formula (1). For example, in embodiments, the LSO material may comprise pure elemental silicon (Si), lithium silicide (LiₓSi, e.g., LiSi), silicon oxide (SiOₓ, e.g., SiO and/or SiO₂), a lithium silicate (LiₓSi_{y}O_{z}, e.g., Li₂Si₂O₅, Li₂SiO₃, Li₆Si₂O₇, and/or Li₄SiO₄), or a combination thereof.

As an electroactive material, silicon suboxide (SiOₓ, where 0<x≤2) can facilitate the storage of lithium in the negative electrode 22 during charge of the battery 20 by forming an alloy with lithium (lithiation) and, during discharge of the battery 20, lithium ions can be released therefrom by dealloying from the SiOₓ (delithiation). However, during initial charge of the battery 20, undesirable irreversible side reactions tend to occur between the lithium ions and the SiOₓ, resulting in the consumption of active lithium, irreversible capacity loss, and a low initial coulombic efficiency. Prelithiating SiOₓ to form the LSO material prior to incorporation in the negative electrode 22 has been found to reduce the occurrence of undesirable irreversible side reactions between lithium and SiOₓ during initial cycling of the battery 20, thereby improving the reversible capacity and cycling stability of the battery 20.

In embodiments, the LSO material may have an open nanoporous structure with open pores (nanopores) having diameters of greater than or equal to about 1 nanometer (nm) and less than or equal to about 100 nm. The LSO material may constitute, by weight, greater than or equal to about 10%, optionally greater than or equal to about 20%, optionally greater than or equal to about 30%, optionally greater than or equal to about 40%, optionally greater than or equal to about 50%, optionally greater than or equal to about 60%, optionally greater than or equal to about 70%, optionally greater than or equal to about 80%, optionally greater than or equal to about 90%, and less than or equal to about 100% of the electroactive material of the negative electrode 22.

In addition to the LSO material, the negative electrode 22 may comprise one or more other electroactive materials. Examples of other electroactive negative electrode materials include lithium, lithium-based materials (e.g., alloys of lithium and silicon, aluminum, indium, and/or tin), carbon-based materials (e.g., graphite, activated carbon, carbon black, hard carbon, soft carbon, and/or graphene), silicon, silicon-based materials (e.g., alloys of silicon and lithium, tin, iron, aluminum, and/or cobalt), silicon oxide, tin oxide, aluminum, indium, zinc, germanium, titanium oxide, lithium titanate, and combinations thereof. In embodiments, the electroactive material of the negative electrode 22 may comprise a composite of the LSO material and graphite. For example, in embodiments, the electroactive material of the negative electrode 22 may comprise the LSO material and graphite.

The polymer binder is electrochemically inactive and is formulated to provide the negative electrode 22 with structural integrity and to help adhere the negative electrode 22 to the major surface of the negative electrode current collector 30. To facilitate manufacture of the negative electrode 22, the polymer binder may be water soluble. Examples of polymer binders include polyvinylidene fluoride (PVDF), polytetrafluoroethylene (PTFE), ethylene propylene diene monomer (EPDM) rubber, styrene butadiene rubber (SBR), carboxymethyl cellulose (CMC), nitrile butadiene rubber (NBR), styrene-butadiene rubber (SBR), styrene ethylene butylene styrene copolymer (SEBS), polyacrylates, alginates, polyacrylic acid (PAA), and combinations thereof. In embodiments, the polymer binder may comprise styrene butadiene rubber (SBR), carboxymethyl cellulose (CMC), sodium carboxymethyl cellulose (Na-CMC), polyacrylic acid (PAA), sodium polyacrylic acid (Na-PAA), lithium polyacrylic acid (Li-PAA), sodium alginate, or a combination thereof. The polymer binder may constitute, by weight, greater than or equal to about 2% and less than or equal to about 10% of the negative electrode 22.

The electrically conductive material is optional and may be included in the negative electrode 22 to provide the negative electrode 22 with good electrical conductivity. Examples of electrically conductive materials include carbon-based materials, metals (e.g., nickel), and/or electrically conductive polymers. Examples of electrically conductive carbon-based materials include carbon black (CB) (e.g., acetylene black), graphene (e.g., graphene nanoplatelets, GNPs), graphene oxide, carbon nanotubes (CNTs) (e.g., single-walled CNTs and/or multi-walled CNTs), and/or carbon fibers (e.g., carbon nanofibers). Examples of electrically conductive polymers include polyaniline, polythiophene, polyacetylene, and/or polypyrrole. When present in the negative electrode 22, the electrically conductive material may constitute, by weight, greater than or equal to about 0.5% and less than or equal to about 10% of the negative electrode 22.

The nitrate additive is formulated to assist in formation of the solid interphase layer 38 on the surfaces 40 of the negative electrode 22. The nitrate additive comprises a metal nitrate. For example, the nitrate additive may comprise lithium nitrate (LiNO₃), sodium nitrate (NaNO₃), potassium nitrate (KNO₃), copper nitrate (Cu(NO₃)₂), or a combination thereof.

The solid interphase layer 38 may inherently form in situ on the surfaces 40 of the negative electrode 22 after assembly of the battery 20 and/or during initial charge and/or cycling of the battery 20, for example, due to chemical reactions between the nitrate additive and the electroactive material of the negative electrode 22. In embodiment, the solid interphase layer 38 may inherently form in situ on the surfaces 40 of the negative electrode 22 during charge and/or cycling of the battery 20 due to the electrochemical reduction of the nitrate additive on the surfaces 40 of the electroactive material of the negative electrode 22. In such case, the solid interphase layer 38 may comprise the electrochemical decomposition products of the nitrate additive. In FIG. 3, the solid interphase layer 38 is depicted as being disposed along an interface between the negative electrode 22 and the separator 26. In practice, however, the solid interphase layer 38 extends throughout the negative electrode 22, between the negative electrode current collector 30 and the separator 26. For example, the solid interphase layer 38 may be disposed on surfaces of the electroactive material particles in the negative electrode 22. In embodiments, the solid interphase layer 38 may extend around and over substantially the entire surface of each of the electroactive material particles in the negative electrode 22 such that each of the electroactive material particles is encapsulated by the solid interphase layer 38.

The solid interphase layer 38 is electrically insulating and ionically conductive and is configured to help prevent undesirable chemical reactions from occurring between the electrolyte 28 and the electroactive material of the negative electrode 22 during cycling of the battery 20. For example, the solid interphase layer 38 may help prevent chemical reactions from occurring between the components of the electrolyte 28 and the electroactive material of the negative electrode 22 during charge and/or discharge of the battery 20. Formation of the solid interphase layer 38 may help prevent undesirable chemical reactions from occurring between the electrolyte 28 and the electroactive material of the negative electrode 22, without impeding the flow of lithium ions between the electrolyte 28 and the negative electrode 22.

The nitrate additive may constitute, by weight, greater than or equal to about 0.01%, or optionally greater than or equal to about 0.05%, and less than or equal to about 2%, or optionally less than or equal to about 0.4%, of the negative electrode 22. In embodiments, the nitrate additive may comprise LiNO₃ and may constitute, by weight, greater than or equal to about 0.05% and less than or equal to about 0.4% of the negative electrode 22.

When the nitrate additive is included in the negative electrode 22 in amounts greater than or equal to about 0.01% and less than or equal to about 2% of the negative electrode 22, the nitrate additive can effectively assist in formation of the solid interphase layer 38 on the surfaces 40 of the negative electrode 22 and thereby improve the capacity retention and cycling stability of the battery 20, as compared to negative electrodes formed without addition of the nitrate additive. In addition, including the nitrate additive in the negative electrode 22 prior to assembly of the battery 20 (i.e., prior to introducing the electrolyte 28 into the battery 20), can help improve the long-term stability of the solid interphase layer 38, thereby avoiding increases in the thickness of the solid interphase layer 38 and avoiding further increases in the internal resistance of the battery 20 after greater than about 20 cycles. In embodiments, it may be desirable for the nitrate additive to constitute, by weight, less than about 0.5% of the negative electrode 22 to help promote the formation of a thin and effective solid interphase layer 38 on the surfaces 40 of the negative electrode 22, without unnecessarily increasing the internal resistance of the battery 20.

The positive electrode 24 is formulated to store and release lithium ions during discharge and charge of the battery 20. The positive electrode 24 may be in the form of a continuous porous layer disposed on the major surface of the positive electrode current collector 32. The positive electrode 24 comprises an electroactive material (electroactive positive electrode material), a polymer binder, and optionally an electrically conductive material.

The electroactive material of the positive electrode 24 can store and release lithium ions by undergoing a reversible redox reaction with lithium at a higher electrochemical potential than the electroactive material of the negative electrode 22 such that an electrochemical potential difference exists between the negative electrode 22 and the positive electrode 24. The electroactive material of the positive electrode 24 may comprise a material that can undergo lithium intercalation and deintercalation or a material that can undergo a conversion reaction with lithium. In aspects where the electroactive material of the positive electrode 24 comprises an intercalation host material that can undergo the reversible insertion or intercalation of lithium ions, the electroactive material of the positive electrode 24 may comprise a lithium transition metal oxide. For example, the electroactive material of the positive electrode 24 may comprise a layered lithium transition metal oxide represented by the formula LiMeO₂, an olivine-type lithium transition metal oxide represented by the formula LiMePO₄, a monoclinic-type lithium transition metal oxide represented by the formula LisMe₂(PO₄)₃, a spinel-type lithium transition metal oxide represented by the formula LiMe₂O₄, a tavorite represented by one or both of the following formulas LiMeSO₄F or LiMePO₄F, or a combination thereof, where Me is a transition metal (e.g., Co, Ni, Mn, Fe, Al, V, or a combination thereof). Specific examples of lithium transition metal oxides include LiNi_{1-x-y}CoₓMn_{y}O₂ (NMC), where 0≤x≤1 and 0≤y≤1; LiNi_{1-x-y-z}COₓMn_{y}Al_{z}O₂ (NCMA), where 0≤x≤1, 0≤y≤1, and 0≤z≤1; LiNi_{1-x-y}CoₓAl_{y}O₂ (NCA), where 0≤x≤1 and 0≤y≤1; LiNiₓMn₁₋ₓO₂ (LNMO), where 0≤x≤1; lithium manganese oxide (LMO) (e.g., Li (1+x) Mn₂O₄, where 0.1≤x≤1); lithium nickel manganese oxide (LiNi_{0.5}Mn_{1.5}O₄); lithium cobalt oxide (LiCoO₂) (LCO); lithium iron phosphate (LiFePO₄); lithium vanadium phosphate (LiVPO₄); lithium manganese iron phosphate (LiMn₁₋ₓFeₓPO₄, where 0≤x≤1); lithium manganese rich layered oxide (LMR); and combinations thereof. In aspects where the electroactive material of the positive electrode 24 comprises a conversion material, the electroactive material of the positive electrode 24 may comprise sulfur, selenium, tellurium, iodine, a halide (e.g., a fluoride or chloride), sulfide, selenide, telluride, iodide, phosphide, nitride, oxide, oxysulfide, oxyfluoride, sulfur-fluoride, sulfur-oxyfluoride, or a lithium and/or metal compound thereof (e.g., a compound of iron, manganese, nickel, copper, and/or cobalt).

The polymer binder is electrochemically inactive and may be included in the positive electrode 24 to provide the positive electrode 24 with structural integrity and/or to help the positive electrode 24 adhere to the major surface of the positive electrode current collector 32. Examples of polymer binders for the positive electrode 24 include polyvinylidene fluoride (PVdF), polytetrafluoroethylene (PTFE), ethylene propylene diene monomer (EPDM) rubber, styrene butadiene rubber (SBR), carboxymethyl cellulose (CMC), nitrile butadiene rubber (NBR), styrene-butadiene rubber (SBR), styrene ethylene butylene styrene copolymer (SEBS), polyacrylates, alginates, polyacrylic acid, and combinations thereof.

The optional electrically conductive material is electrochemically inactive and may be included in the positive electrode 24 to provide the positive electrode 24 with sufficient electrical conductivity to support the percolation of electrons therethrough. Examples of electrically conductive materials for the positive electrode 24 include carbon-based materials, metals (e.g., nickel), and/or electrically conductive polymers. Examples of electrically conductive carbon-based materials include carbon black (CB) (e.g., acetylene black), graphite, graphene (e.g., graphene nanoplatelets, GNP), graphene oxide, carbon nanotubes (CNT), and/or carbon fibers (e.g., carbon nanofibers). Examples of electrically conductive polymers for the positive electrode 24 include polyaniline, polythiophene, polyacetylene, and/or polypyrrole.

The separator 26 is configured to physically separate and electrically isolate the negative electrode 22 and the positive electrode 24 from each other while permitting lithium ions to pass therethrough. The separator 26 has an open microporous structure and may comprise an organic and/or inorganic material. For example, the separator 26 may comprise a polymer, e.g., a polyolefin. In embodiments, the separator 26 may comprise polyethylene (PE), polypropylene (PP), polyamide (PA), poly(tetrafluoroethylene) (PTFE), polyvinylidene fluoride (PVDF), and/or poly(vinyl chloride) (PVC).

The electrolyte 28 is ionically conductive and is formulated to provide a medium for the conduction of lithium ions between the negative electrode 22 and the positive electrode 24. The electrolyte 28 comprises an organic solvent, a lithium salt in the organic solvent, and optionally an electrolyte additive.

The organic solvent may comprise a nonaqueous polar aprotic organic solvent. Non-limiting examples of non-aqueous polar aprotic organic solvents include cyclic carbonates (e.g., ethylene carbonate (EC), propylene carbonate (PC), butylene carbonate (BC), fluoroethylene carbonate (FEC), and vinylene carbonate (VC)); linear carbonates (e.g., dimethyl carbonate (DMC), diethyl carbonate (DEC), ethyl methyl carbonate (EMC)); aliphatic carboxylic esters (e.g., methyl formate, methyl acetate, methyl propionate); lactones (e.g., γ-butyrolactone, γ-valerolactone, and/or δ-valerolactone); nitriles (e.g., succinonitrile, glutaronitrile, and/or adiponitrile); sulfones (e.g., tetramethylene sulfone, ethyl methyl sulfone, vinyl sulfone, phenyl sulfone, 4-fluorophenyl sulfone, benzyl sulfone, and/or sulfolane); aliphatic ethers (e.g., triethylene glycol dimethyl ether, tetraethylene glycol dimethyl ether, 1,3-dimethoxypropane, 1,2-dimethoxyethane, 1-2-diethoxyethane, and/or ethoxymethoxyethane); cyclic ethers (e.g., 1,4-dioxane, tetrahydrofuran, 2-methyltetrahydrofuran), 1,3-dioxolane); phosphates (e.g., triethyl phosphate and/or trimethyl phosphate); and combinations thereof. In embodiments, the organic solvent may comprise a mixture of a cyclic carbonate (e.g., EC) and a linear carbonate (e.g., DMC).

The lithium salt is soluble in the organic solvent and provides a passage for lithium ions through the electrolyte 28. The lithium salt may comprise an inorganic lithium salt, an organic lithium salt, or a combination thereof. Examples of lithium salts include lithium hexafluorophosphate (LiPF₆), lithium difluorophosphate (LiPO₂F₂), lithium perchlorate (LiClO₄), lithium tetrachloroaluminate (LiAlCl₄), lithium iodide (LiI), lithium bromide (LiBr), lithium thiocyanate (LiSCN), lithium tetrafluoroborate (LiBF₄), lithium hexafluoroarsenate (LiAsF₆), lithium trifluoromethanesulfonate (LiCF₃SO₃), lithium bis(trifluoromethane) sulfonylimide (LiN(CF₃SO₂)₂), lithium bis(fluorosulfonyl)imide (LiN(FSO₂)₂) (LiSFI), lithium tetraphenylborate (LiB(C₆H₅)₄), lithium bis(oxalato) borate (LiB(C₂O₄)₂) (LiBOB), lithium difluoro (oxalato) borate (LiBF₂(C₂O₄)) (LiDFOB), and combinations thereof.

The optional electrolyte additive is formulated to assist in formation of the solid interphase layer 38 on the surfaces 40 of the negative electrode 22. Examples of such electrolyte additives include fluoroethylene carbonate (FEC), vinylene carbonate (VC), lithium bis(oxalato) borate (LiBOB), lithium difluoro (oxalate) borate (LiDFOB), lithium fluoromalonato (difluoro) borate (LiFMDFB), and combinations thereof. When present, the electrolyte additive may constitute, by weight, greater than or equal to about 0.5% and less than or equal to about 2% of the electrolyte 28.

The electrolyte 28 and the separator 26 may be substantially free of nitrate compounds. In particular, the electrolyte 28 and the separator 26 may be substantially free of LiNO₃, NaNO₃, KNO₃, and/or copper nitrate (Cu(NO₃)₂.

The negative electrode current collector 30 and the positive electrode current collector 32 are electrically conductive and provide an electrical connection between the external circuit 36 and the negative electrode 22 and the positive electrode 24, respectively. In aspects, the negative electrode current collector 30 and the positive electrode current collector 32 may be made of metal and may be in the form of nonporous metal foils, perforated metal foils, porous metal meshes, or a combination thereof. The negative electrode current collector 30 may be made of copper, nickel, or alloys thereof, stainless steel, or other appropriate electrically conductive material. The positive electrode current collector 32 may be made of aluminum (Al) or another appropriate electrically conductive material.

### Methods

The negative electrode 22 may be manufactured by depositing a precursor mixture on a metal substrate to form a precursor layer. The precursor mixture comprises the electroactive negative electrode material (i.e., the LSO material and optionally one or more other electroactive materials), the polymer binder, the nitrate additive, and the optional electrically conductive material in an aqueous solvent, e.g., water. After the precursor layer is formed on the metal substrate, the aqueous solvent is removed from the precursor layer (e.g., by evaporation) to form the negative electrode 22 on the metal substrate. In embodiments, the metal substrate may be made of substantially the same material as that of the negative electrode current collector 30. For example, the metal substrate may comprise a copper current collector.

Introducing the nitrate additive into the negative electrode 22 during manufacture thereof and prior to assembly of the battery 20, instead of introducing the nitrate additive into the negative electrode 22 (and the battery 20) along with the electrolyte 28 provides several notable benefits. First, the nitrate additive has exceptionally high solubility in the solvent, e.g., water, as compared to the solubility of the nitrate additive in the organic solvent included in the electrolyte 28. As such, including the nitrate additive in the precursor mixture used to form the negative electrode 22 helps more uniformly distribute the nitrate additive throughout the negative electrode 22 and ensures more intimate contact between the electroactive negative electrode material and the nitrate additive, as compared to introducing the nitrate additive into the battery 20 (and the negative electrode 22) along with the electrolyte 28 during assembly of the battery 20 (after formation of the negative electrode 22).

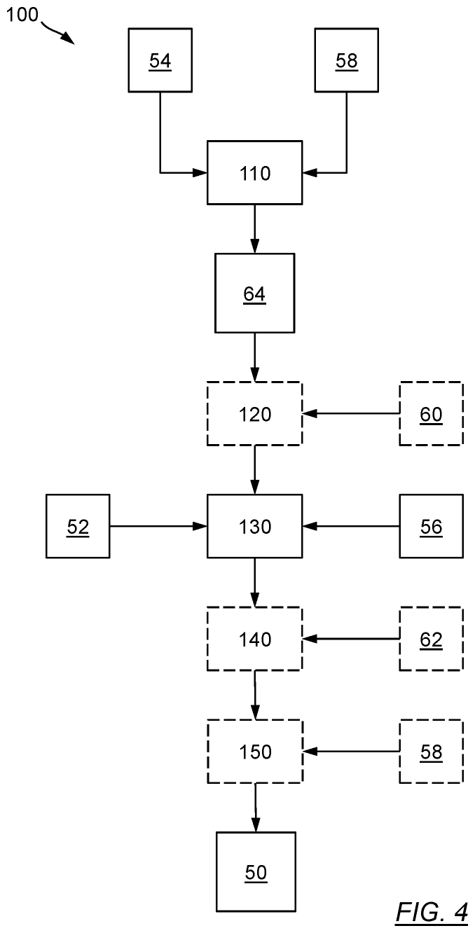

FIGS. 4, 5, and 6 respectively depict first, second, and third methods 100, 200, 300 for preparing a precursor mixture 50 including an electroactive negative electrode material 52, a polymer binder 54, a nitrate additive 56, an aqueous solvent 58, optionally an electrically conductive material 60, and optionally a supplemental binder 62. The electroactive negative electrode material 52, the polymer binder 54, the nitrate additive 56, and the optional electrically conductive material 60 may comprise substantially the same material as the electroactive negative electrode material, the polymer binder, the nitrate additive, and the optional electrically conductive material described above with respect to the negative electrode 22 and may be present in the precursor mixture 50 in substantially the same proportions. The aqueous solvent 58 comprises water and the optional supplemental binder 62 may comprise styrene butadiene rubber (SBR). The first, second, and third methods 100, 200, 300 may be prepared at about ambient temperature (e.g., about 25 degrees Celsius (C)).

As shown in FIG. 4, in the first method 100, in a first step 110, the polymer binder 54 and at least a portion of the aqueous solvent 58 are mixed together at a low shear rate to form a binder solution 64. In an optional second step 120, in embodiments where the precursor mixture 50 comprises the electrically conductive material 60, the electrically conductive material 60 is introduced into and mixed with the polymer binder 54 and the aqueous solvent 58 in the binder solution 64 at a low shear rate, followed by mixing at a relatively high shear rate. In a third step 130, the electroactive negative electrode material 52 and the nitrate additive 56 are introduced into and mixed with the polymer binder 54, the aqueous solvent 58, and the optional electrically conductive material 60 in the binder solution 64 at a low shear rate, followed by mixing at a relatively high shear rate, to form the precursor mixture 50. In an optional fourth step 140, in embodiments where the precursor mixture 50 comprises the supplemental binder 62, the supplemental binder 62 is introduced into and mixed with a composition comprising the polymer binder 54, the aqueous solvent 58, the optional electrically conductive material 60, the electroactive negative electrode material 52, and the nitrate additive 56 at a low shear rate to form the precursor mixture 50. In an optional fifth step 150, an additional amount of the aqueous solvent 58 may be introduced into and mixed with a composition comprising the polymer binder 54, the aqueous solvent 58, the optional electrically conductive material 60, the electroactive negative electrode material 52, the nitrate additive 56, and the optional supplemental binder 62 at a low shear rate to form the precursor mixture 50.

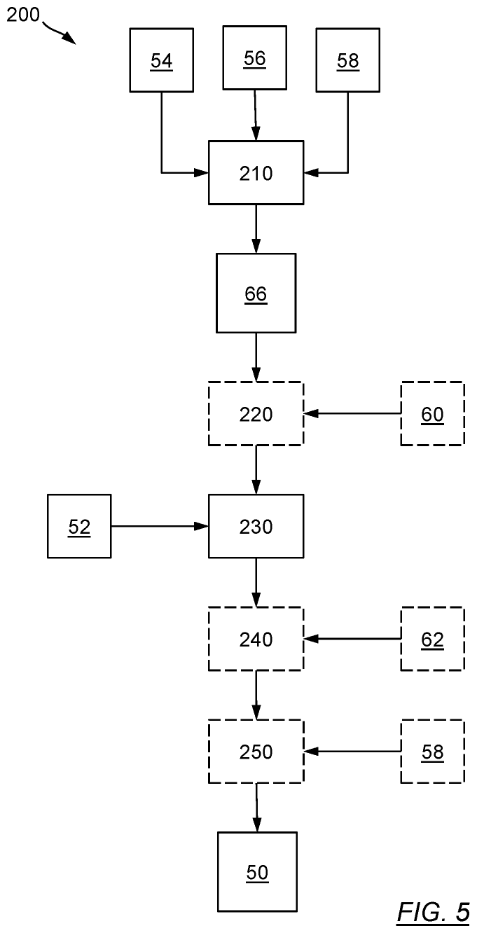

As shown in FIG. 5, in the second method 200, in a first step 210, the polymer binder 54, the nitrate additive 56, and at least a portion of the aqueous solvent 58 are mixed together at a low shear rate to form a first solution 66. In an optional second step 220, in embodiments where the precursor mixture 50 comprises the electrically conductive material 60, the electrically conductive material 60 is introduced into and mixed with the polymer binder 54, the nitrate additive 56, and the aqueous solvent 58 in the first solution 66 at a low shear rate, followed by mixing at a relatively high shear rate. In a third step 230, the electroactive negative electrode material 52 is introduced into and mixed with the polymer binder 54, the nitrate additive 56, the aqueous solvent 58, and the optional electrically conductive material 60 in the first solution 66 at a low shear rate, followed by mixing at a relatively high shear rate, to form the precursor mixture 50. In an optional fourth step 240, in embodiments where the precursor mixture 50 comprises the supplemental binder 62, the supplemental binder 62 is introduced into and mixed with a composition comprising the polymer binder 54, the nitrate additive 56, the aqueous solvent 58, the electroactive negative electrode material 52, and the optional electrically conductive material 60 at a low shear rate to form the precursor mixture 50. In an optional fifth step 250, an additional amount of the aqueous solvent 58 may be introduced into and mixed with a composition comprising the polymer binder 54, the nitrate additive 56, the aqueous solvent 58, the electroactive negative electrode material 52, the optional electrically conductive material 60, and the optional supplemental binder 62 at a low shear rate to form the precursor mixture 50.

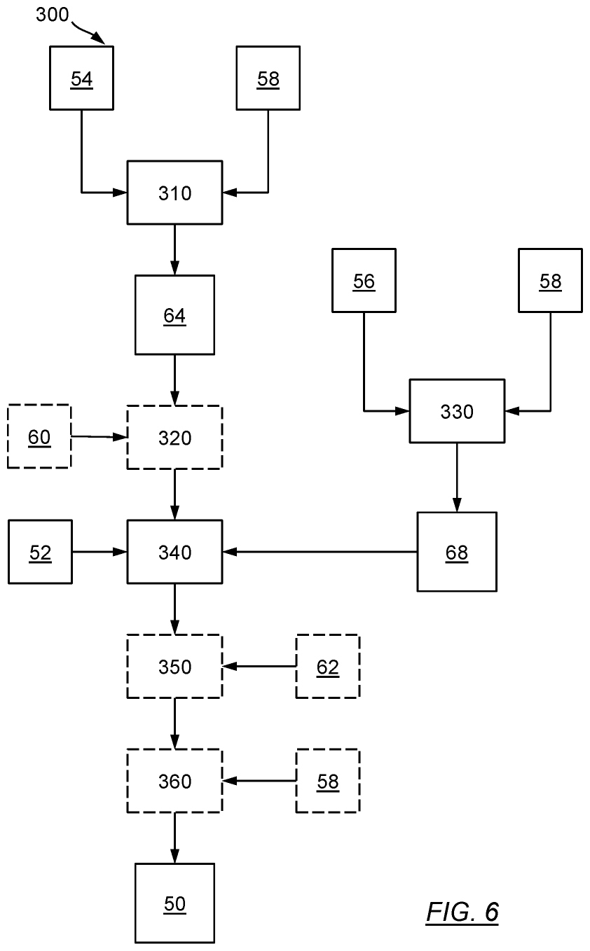

As shown in FIG. 6, in the third method 300, in a first step 310, the polymer binder 54 and at least a portion of the aqueous solvent 58 are mixed together at a low shear rate to form a binder solution 64. In an optional second step 320, in embodiments where the precursor mixture 50 comprises the electrically conductive material 60, the electrically conductive material 60 is introduced into and mixed with the polymer binder 54 and the aqueous solvent 58 in the binder solution 64 at a low shear rate, followed by mixing at a relatively high shear rate. In a third step 330, the nitrate additive 56 and at least a portion of the aqueous solvent 58 are mixed together at a low shear rate to form a nitrate solution 68. In a fourth step 340, the electroactive negative electrode material 52 and the nitrate solution 68 are introduced into and mixed with a composition comprising the polymer binder 54, the aqueous solvent 58, and the optional electrically conductive material 60 at a low shear rate, followed by mixing at a relatively high shear rate, to form the precursor mixture 50. In an optional fifth step 350, in embodiments where the precursor mixture 50 comprises the supplemental binder 62, the supplemental binder 62 is introduced into and mixed with a composition comprising the polymer binder 54, the nitrate additive 56, the aqueous solvent 58, the electroactive negative electrode material 52, and the optional electrically conductive material 60 at a low shear rate to form the precursor mixture 50. In an optional sixth step 360, an additional amount of the aqueous solvent 58 may be introduced into and mixed with a composition comprising the polymer binder 54, the nitrate additive 56, the aqueous solvent 58, the electroactive negative electrode material 52, the optional electrically conductive material 60, and the optional supplemental binder 62 at a low shear rate to form the precursor mixture 50.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.” As used herein, the term “and/or” includes combinations of one or more of the associated listed items.

The terminology used herein is for the purpose of describing example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended terms “comprises,” “comprising,” “including,” and “having,” are to be understood as non-restrictive terms used to describe and claim various embodiments set forth herein, in certain aspects, the terms may alternatively be understood to instead be a more limiting and restrictive term, such as “consisting of” or “consisting essentially of.” Thus, for any given embodiment reciting compositions, materials, components, elements, ingredients, features, integers, operations, and/or process steps, the present disclosure also specifically includes embodiments consisting of, or consisting essentially of, such recited compositions, materials, components, elements, ingredients, features, integers, operations, and/or process steps. In the case of “consisting of,” the alternative embodiment excludes any additional compositions, materials, components, elements, ingredients, features, integers, operations, and/or process steps, while in the case of “consisting essentially of,” any additional compositions, materials, components, elements, ingredients, features, integers, operations, and/or process steps that materially affect the basic and novel characteristics are excluded from such an embodiment, but any compositions, materials, components, elements, ingredients, features, integers, operations, and/or process steps that do not materially affect the basic and novel characteristics can be included in the embodiment.

Any method steps, processes, and operations described herein are not to be construed as necessarily requiring their performance in the order discussed or illustrated, unless specifically identified as an order of performance. It is also to be understood that additional or alternative steps may be employed, unless otherwise indicated. Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer, or section. Terms such as “first,” “second,” and other numerical terms when used herein do not imply a sequence or order unless clearly indicated by the context. Thus, a first step, element, component, region, layer, or section discussed below could be termed a second step, element, component, region, layer, or section without departing from the teachings of the example embodiments.

Throughout this disclosure, the numerical values represent approximate measures or limits to ranges and encompass minor deviations from the given values and embodiments, having about the value mentioned as well as those having exactly the value mentioned. Other than the working examples provided at the end of the detailed description, all numerical values of parameters (e.g., of quantities or conditions) in this specification are to be understood as being modified in all instances by the term “about” whether or not “about” actually appears before the numerical value. Numerical values of parameters in the appended claims are to be understood as being modified by the term “about” only when such term appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%. In addition, disclosure of ranges includes disclosure of all values and further divided ranges within the entire range, including endpoints and sub-ranges given for the ranges.

As used herein, the terms “composition” and “material” are used interchangeably to refer broadly to a substance containing at least the preferred chemical constituents, elements, or compounds, but which may also comprise additional elements, compounds, or substances, including trace amounts of impurities, unless otherwise indicated. An “X-based” composition or material broadly refers to compositions or materials in which “X” is the single largest constituent of the composition or material on a weight percentage (%) basis. This may include compositions or materials having, by weight, greater than 50% X, as well as those having, by weight, less than 50% X, so long as X is the single largest constituent of the composition or material based upon its overall weight. When a composition or material is referred to as being “substantially free” of a substance, the composition or material may comprise, by weight, less than 5%, optionally less than 3%, optionally less than 1%, or optionally less than 0.1% of the substance.

As used herein, the term “metal” may refer to a pure elemental metal or to an alloy of an elemental metal and one or more other metal or nonmetal elements (referred to as “alloying” elements).

What is claimed is:

1. A method of manufacturing a negative electrode for a battery that cycles lithium ions, the method comprising:
depositing a precursor mixture on a substrate to form a precursor layer, the precursor mixture comprising an electroactive negative electrode material, a polymer binder, a nitrate additive, and an aqueous solvent, the electroactive negative electrode material comprising silicon, silicon oxide, lithiated silicon suboxide, graphite, or a combination thereof; and
removing the aqueous solvent from the precursor layer to form the negative electrode on the substrate.

2. The method of claim 1, wherein the nitrate additive comprises lithium nitrate (LiNO₃), sodium nitrate (NaNO₃), potassium nitrate (KNO₃), copper nitrate (Cu(NO₃)₂), or a combination thereof.

3. The method of claim 1, wherein the nitrate additive constitutes, by weight, greater than or equal to about 0.01% and less than or equal to about 2% of the negative electrode.

4. The method of claim 1, further comprising:
preparing the precursor mixture by:
preparing a binder solution comprising the polymer binder and at least a portion of the aqueous solvent; and then
introducing the electroactive negative electrode material and the nitrate additive into the binder solution to form the precursor mixture.

5. The method of claim 4, further comprising:
introducing an electrically conductive material into the binder solution prior to introducing the electroactive negative electrode material and the nitrate additive into the binder solution.

6. The method of claim 1, further comprising:
preparing the precursor mixture by:
preparing a first solution comprising the polymer binder, the nitrate additive, and at least a portion of the aqueous solvent; and
introducing the electroactive negative electrode material into the first solution to form the precursor mixture.

7. The method of claim 6, wherein preparing the precursor mixture further comprises:
introducing an electrically conductive material into the first solution prior to introducing the electroactive negative electrode material into the first solution.

8. The method of claim 1, further comprising:
preparing the precursor mixture by:
preparing a binder solution comprising the polymer binder and the aqueous solvent;
preparing a nitrate solution comprising the nitrate additive and the aqueous solvent; and
mixing the binder solution, the nitrate solution, and the electroactive negative electrode material together to form the precursor mixture.

9. The method of claim 8, wherein preparing the precursor mixture further comprises:
introducing an electrically conductive material into the binder solution prior to mixing the binder solution with the nitrate solution and the electroactive negative electrode material.

10. The method of claim 1, wherein the polymer binder comprises styrene butadiene rubber (SBR), carboxymethyl cellulose (CMC), polyacrylic acid (PAA), sodium alginate, or a combination thereof, and wherein the polymer binder constitutes, by weight, greater than or equal to about 2% and less than or equal to about 10% of the negative electrode.

11. The method of claim 1, wherein the precursor mixture further comprises an electrically conductive material, and wherein the electrically conductive material constitutes, by weight, greater than or equal to about 2% and less than or equal to about 10% of the negative electrode.

12. The method of claim 1, wherein the electroactive negative electrode material constitutes, by weight, greater than or equal to about 80% and less than or equal to about 97% of the negative electrode.

13. The method of claim 1, wherein the electroactive negative electrode material further comprises graphite.

14. A method of manufacturing a battery that cycles lithium ions, the method comprising:
depositing a precursor mixture on a copper current collector to form a precursor layer, the precursor mixture comprising an electroactive negative electrode material, a polymer binder, a nitrate additive, and an aqueous solvent, the electroactive negative electrode material comprising silicon, silicon oxide, lithiated silicon suboxide, graphite, or a combination thereof, the nitrate additive comprising lithium nitrate (LiNO₃), sodium nitrate (NaNO₃), potassium nitrate (KNO₃), copper nitrate (Cu(NO₃)₂), or a combination thereof;
removing the aqueous solvent from the precursor layer to form a negative electrode on the copper current collector; and
assembling the negative electrode and the copper current collector into a stack comprising a positive electrode disposed on a positive electrode current collector and a separator sandwiched between opposed facing surfaces of the negative electrode and the positive electrode, the positive electrode comprising lithium ions.

15. The method of claim 14, wherein the nitrate additive comprises LiNO₃, and wherein the LiNO₃ constitutes, by weight, greater than or equal to about 0.05% and less than or equal to about 0.4% of the negative electrode.

16. The method of claim 14, wherein the polymer binder comprises styrene butadiene rubber (SBR), carboxymethyl cellulose (CMC), polyacrylic acid (PAA), sodium alginate, or a combination thereof.

17. The method of claim 14, further comprising:
infiltrating the negative electrode, the positive electrode, and the separator with an electrolyte comprising a lithium salt in a polar aprotic organic solvent, the electrolyte being substantially free of nitrate compounds; and
charging the battery by electrically coupling the negative electrode current collector and the positive electrode current collector to a power source such that lithium ions are released from the positive electrode and incorporated into the negative electrode,
wherein, during charge of the battery, the nitrate additive reacts with the electroactive negative electrode material to form an electrically insulating and ionically conductive solid interphase layer on surfaces of the electroactive negative electrode material.

18. The method of claim 14, wherein the polar aprotic organic solvent comprises a mixture of a cyclic carbonate and a linear carbonate.

19. A battery that cycles lithium ions, the battery comprising:
a negative electrode comprising electroactive negative electrode material particles, nitrate additive particles, and an electrically conductive carbon-based material intermingled with a polymer binder, the electroactive negative electrode material particles comprising silicon, silicon oxide, lithiated silicon suboxide, graphite, or a combination thereof, the nitrate additive particles comprising lithium nitrate (LiNO₃), sodium nitrate (NaNO₃), potassium nitrate (KNO₃), copper nitrate (Cu(NO₃)₂), or a combination thereof and constituting, by weight, greater than or equal to about 0.05% and less than or equal to about 0.4% of the negative electrode, the polymer binder comprising styrene butadiene rubber (SBR), carboxymethyl cellulose (CMC), polyacrylic acid (PAA), sodium alginate, or a combination thereof;
a positive electrode spaced apart from the negative electrode and comprising an electroactive positive electrode material;
a separator sandwiched between the negative electrode and the positive electrode; and
an electrolyte infiltrating the negative electrode, the positive electrode, and the separator, the electrolyte comprising a lithium salt in a polar aprotic organic solvent,
wherein the electrolyte and the separator are substantially free of nitrate compounds.

20. The battery of claim 19, wherein the electrolyte further comprises an electrolyte additive selected from the group consisting of lithium bis(oxalato) borate (LiBOB), lithium difluoro (oxalate) borate (LiDFOB), and lithium fluoromalonato (difluoro) borate (LIFMDFB), and wherein the electrolyte additive constitutes, by weight, greater than or equal to about 0.5% and less than or equal to about 2% of the electrolyte.
